(19) United States
(12) Patent Application Publication
(10) Pub. No.: US 2004/0138885 A1
(43) Pub. Date: Jul. 15, 2004

(54) Commercial automatic speech recognition engine combinations

(76) Inventor: Xiaofan Lin, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/339,423

(22) Filed: Jan. 9, 2003

(51) Int. Cl. G10L 15/12

(52) U.S. Cl. 704/240

(57) ABSTRACT

A combination system of speech recognition engines comprises a pool of speech recognition engines that vary amongst themselves in various characterizing measures like processing speed, error rates, cost, etc. One such speech recognition engine is designated as primary and others are designated as supplemental, according to the job at hand and the peculiar benefits of using each selected engine. The primary engine is run on every job. A supplemental engine may be run if some measure indicates more speed or more accuracy is needed. A combination unit aligns and combines the outputs of the primary and supplemental engines. Any grammar constraints are enforced by the combination unit in the final result. A finite state machine is generated from the grammar constraints, and is used to guide the search in word transition network for an optimal final string.

### FIELD OF THE INVENTION

The present invention relates to automatic speech-recognition systems, and more specifically to systems that combine multiple speech recognition engines with particular characteristics into teams that favor predetermined business goals.

### BACKGROUND OF THE INVENTION

Telephone applications of automatic speech recognition (ASR) promise huge economic returns by being able to reduce the costs of business transactions and services through computerized speech interfaces. Nuance Communications, Inc., (Menlo Park Calif.) and SpeechWorks International, Inc., (Boston, Calif.) are two leading suppliers of such software. Many such systems often provide the same functionality, so a natural inclination is to combine the systems for better performance.

Prior art combinations of multiple conversational ASR engines have been principally directed toward reducing the word error rate (WER). A voting mechanism is usually constructed in which a majority vote decides what is the correct output response to an input utterance. Such arrangements can significantly improve the word error rates over single recognition engines.

But many prior solutions are only simple combination units that do not consider grammar rules. In addition, they try to maximize accuracy by running all the recognition engines. The combined systems are slower because each engine's software takes time to execute on the hardware platform, and they together impose a higher software licensing cost because a license for each engine used must be bought. These combinations typically do not take rule-based grammar into consideration, and cannot be used directly for telephony-type ASR engines. Prior art combination methods do not contribute much business value on top of telephony-type ASR engines.

### SUMMARY OF THE INVENTION

An object of the present invention is to provide a method for combining automatic speech recognition engines.

Another object of the present invention is to provide a method for assigning speech recognition engines dynamically into various team combinations.

A further object of the present invention is to provide a combination system of speech recognition engines.

Briefly, a speech recognition engine combination system embodiment of the present invention comprises a pool of speech recognition engines that vary amongst themselves in various characterizing measures like processing speed, error rates, cost, etc. One such speech recognition engine is designated as primary and others are designated as supplemental, according to the job at hand and the peculiar benefits of using each selected engine. The primary engine is run on every job. A supplemental engine may be run if some measure indicates more speed or more accuracy is needed. A combination unit aligns and combines the outputs of the primary and supplemental engines. Any grammar constraints are enforced by the combination unit in the final result. A finite state machine is generated from the grammar constraints, and such guides the search in word transition network for an optimal final string.

An advantage of the present invention is speech recognition systems are provided that can be optimized for recognition rate, speed, cost, or other business goals.

An advantage of the present invention is that speech recognition systems are provided that are inexpensive, higher performing, and portable.

A further advantage of the present invention is that a speech recognition system is provided that reduces costs by requiring fewer licensed recognition engines. The cost of the combination system is directly proportional to the number of ASR engines used in the combination method.

A still further advantage of the present invention is that a speech recognition system is provided that improves performance because processor resources are spread across fewer executing ASR engines. Systems using the present invention will be faster and will have a shorter response time in telephony applications.

Another advantage of the present invention is that a speech recognition system is provided that can trade-off accuracy versus speed, depending on a predetermined business goal.

A further advantage of the present invention is that a speech recognition system is provided that is independent of specific ASR engines and languages.

Another advantage of the present invention is that a speech recognition system is provided that allows a generic middleware to be built in which different ASR engines can then be plugged in.

These and other objects and advantages of the present invention will no doubt become obvious to those of ordinary skill in the art after having read the following detailed description of the preferred embodiment as illustrated in the drawing figures.

### DESCRIPTION OF THE DRAWINGS

FIG. 1 is a functional block diagram of a speech recognition system embodiment of the resent invention; and

FIG. 2 is a state diagram showing the processing of a three-digit number input utterance as in FIG. 1; and

FIG. 3 is a flowchart diagram of a path search method embodiment of the present invention

### DETAILED DESCRIPTION OF THE EMBODIMENTS

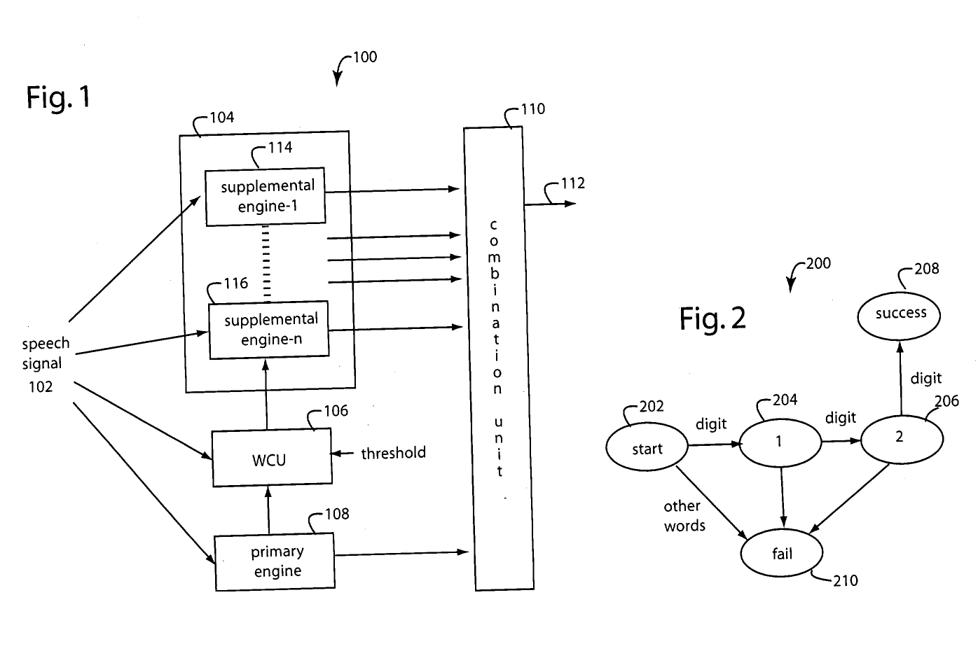

FIG. 1 represents a speech recognition system embodiment of the present invention, and is referred to herein by the general reference numeral 100. The system 100 comprises a speech signal input 102, a speech recognition engine pool 104, a workflow control unit (WCU) 106, a primary engine 108, and a combination unit (CU) 110 with an output 112. The speech recognition engine pool 104 comprises a plurality of ASR engines, as represented by a first supplemental engine 114 through an n^{th} supplemental engine 116.

Embodiments of the present invention are implemented with multiple non-identical commercial-off-the-shelf (COTS) telephony-type ASR engines. Such ASR engines are designated as primary engine 108 and supplemental engines 114-116 in FIG. 1. Some of these ASR engines excel in recognition rates, and some excel in performance, but all are not equal in cost, construction, or performance. Combinations of ASR engines are assigned in ad hoc teams according to how well they can reduce word error rates (WER), lower licensing cost, accelerate speech recognition, and meet other business criteria.

The ASR engines are assigned to function either as the primary engine (PE) 108 or as any one of a number of supplemental engines (SE's) 114-116. Once the primary engine 108 is chosen, it is used to process every input utterance carried in by the speech signal 102. In contrast, some of the supplemental engines are used to process only some of the input samples. The workflow control unit (WCU) 106 balances the ASR-assets appointed to each particular job according to predetermined business operational goals.

For example, if the business operational goal is a high recognition rate, the particular primary engine selected from the engines in the inventory is the one with the best overall recognition rate. If speed of recognition is the top priority, the fastest engine in the inventory is appointed to be the primary engine 108. Such, of course, implies that all the ASR engines have been comparatively characterized and their attributes are each understood.

The workflow control unit 106 decides whether to invoke supplemental engines 114-116. It inputs raw speech data from speech signal 102 and the results from PE 108. In some embodiments, only a confidence score from PE 108 is used. The user can preferably set an accuracy and speed/cost threshold to adjust where the WCU 106 makes its tradeoff decisions. See, Lin, X., et al, (1998), “Adaptive confidence transform based classifier combination for Chinese character recognition,” Pattern Recognition Letters 19(10), 975-988.

When the supplemental engines 114-116 are invoked, the results from all the recognition engines are integrated into a single final result by the combination unit 110. The CU 110 has rule-based grammar constraints that are embedded into the combination process.

The WCU 106 decides whether to invoke any and which supplemental ASR engines to use in pool 104. A full combination of all the available ASR engines is only necessary for difficult-to-recognize utterances. Otherwise, a single engine (PE 108) may be sufficient. Embodiments of the present invention are therefore differentiated from conventional systems by their ability to selectively run supplementary recognition engines.

The ASR engines are typically implemented in software and run on the same hardware platform. So one ASR engine must finish executing before the next one can, or if both execute concurrently then the processor CPU-time must be shared. In either event, running multiple ASR engines usually means more time is needed. If a secondary or supplemental ASR engine is run only a fraction of the time, then the overall speed is improved. If the instances in which these supplemental engines are run is restricted to difficult-to-recognize utterances, then the error rates can be improved disproportionately to the sacrifices made in speed.

In real-world telecom applications the throughput is usually limited by call volumes, allowed waiting times, average transaction lengths, and other business requirements. Increased throughput is conventionally obtainable by duplicating the hardware and software so the computations can be done in parallel. But this increases both hardware and software costs, the increased ASR engine licensing costs can be substantial.

Experiments conducted with a Linguistic Data Consortium (LDC) PhoneBook database and three ASR engines showed that most of recognition rate increases can be retained even when the supplemental engines are only engaged a fraction of the time. (See, www.ldc.upenn.edu for LDC information.) Table-I represents a comparison of different numbers of licenses, e.g., with a PE alone, a full combination, and a combination like that of system 100 in FIG. 1. The PE was a commercially marketed SpeechWorks engine. All else being the same, the system 100 can significantly reduce the number of licenses needed with only minor sacrifices in the WER.

Table-I shows that a typical WER reduction with system 100 can be 67% of that of the full combination. Such is quite impressive considering multiple times of speed increase or licensing cost decrease compared with a full combination. The targeted throughput is T words/second. Each engine can recognize S words/second.

TABLE-I

| | PE Only | Full Combination | System 100 Combination |
|---|---|---|---|
| number of | T/S | T/S licenses for | T/S licenses for PE and |
| licenses | licenses | each of the 3 | 0.2 T/S licenses for each |
| | for PE | ASR engines | of the 2 supplemental |
| | | | engines |
| word error rate | 3.06 | 2.47 | 2.67 |
| (WER) | | | |

The recognition rate can also be improved dramatically with system 100 without a proportionate sacrifice in the recognition accuracy. This can translate into higher speed and/or lower licensing costs.

The WCU 106 looks at how reliable the output is from PE 108. In alternative embodiments of the present invention, WCU 106 uses both the original speech signal 102 and the results from PE 108 to draw a conclusion. In other embodiments, WCU 106 depends only on a confidence score reported by PE 108.

If PE 108 reports a confidence score lower than a preset threshold, supplemental engines are appointed to help recognize the utterance at signal input 102. A tradeoff can be achieved between the recognition rate and the speed/cost by adjusting the threshold or setpoint value. In the previous experiment, the threshold of WCU is set to be 0.91. With a threshold of one, the combination becomes a full-parallel combination. If the threshold is zero, only the PE is used on all input utterances.

The combination unit (CU) 110 aligns word strings from the ASR engines, builds a finite state machine (FSM) from the grammar rules, and searches the optimal combination result.

Almost all commercial telephony-type ASR systems require users to define grammar rules for the utterance so the search space can be limited and the recognition rates will be reasonably good. But sometimes pieces that each comply with the grammar rules can be combined into something outside the grammar. For example, if the grammar rules only allow dates to be recognized, a simple combination without grammar constraints may lead to a finished output of “February 30^{th}”, which is impossible and out of grammar.

The combination unit 110 must align the word strings from the ASR engines because such engines do not necessarily keep a simple one-to-one correspondence. Conventional alignment algorithms based on dynamic programming can be used. For example, the National Institute of Science and Technology (NIST) Rover system was used in prototypes to align multiple word strings into a word transition network (WTN). See, Fiscus, J. G., (1997), “A post-processing system to yield reduced word error rates: Recognizer output voting error reduction (ROVER),” Proceedings of IEEE Automatic Speech Recognition and Understanding Workshop, Santa Barbara, USA, 347-352.

Table-II represents the alignment of three sample strings, e.g., “five-one-oh-four”, “oh”, and “nine-one-four”. The “@” in the Table represents a null (blank word).

TABLE-II

| | | | |
|---|---|---|---|
| five | one | oh | four |
| @ | @ | oh | @ |
| nine | one | @ | four |

FIG. 2 illustrates a typical finite state machine (FSM) 200 built from a set of rules of grammar. Telephony applications will have well structured rules of grammar to govern any utterance. The rules can be defined either in standard formats, such as W3C Speech Grammar Markup Language Specification (http://www.w3.org/TR/2001/WD-speech-grammar-20010103/), or in proprietary formats such as Nuance's Grammar Specification Language (GSL).

The Speech Grammar Markup Language Specification defines syntax for representing grammars for use in speech recognition so that developers can specify the words and patterns of words to be listened for by a speech recognizer. The syntax of the grammar format is presented in augmented BNF-syntax and XML-syntax, and are directly mappable for automatic transformations between them.

In embodiments of the present invention, the grammar rules are converted to FSM. The corresponding FSM 200 for a “three-digit string” rule is represented in FIG. 2. A “start” state 202 is the starting point. If a first digit is detected a state-1 204 is visited. If a second digit is detected a state-2 206 is visited. And if a third digit is detected a “success” state 208 is visited. Otherwise, a “fail” state 210 results.

The search for an optimal combination is preferably guided by an FSM. A search in the word transition network is made for the optimal final string. A depth-first search through the word transition network is constructed in step 202. With each step in the search, the state of FSM is correspondingly changed. If the FSM enters the “fail” state 210, the path is aborted and a new search is initiated through back-tracking. If a path ends in the “success” state 208, a score is assigned to the path. A path “P” is defined as the one that reaches “success” state in the FSM. It consists a string of words {w₁, w₂, . . . wₙ}. For example, the score assigned to P can be the sum of scores assigned to individual words, e.g.,

$$S ( P ) = {\sum }_{i = i}^{n} S ( {w}_{i} ) .$$

The number of engines selecting Wᵢ can be defined as being S(wᵢ). Where each engine outputs a confidence score for each recognized word, S(wᵢ) can alternatively represent the sum of the confidence scores.

If the score is higher than a preexisting best score, the path replaces the previous best path, and the best score is updated. Such process continues until all the legitimate paths are exhausted. The surviving path is the final combination result.

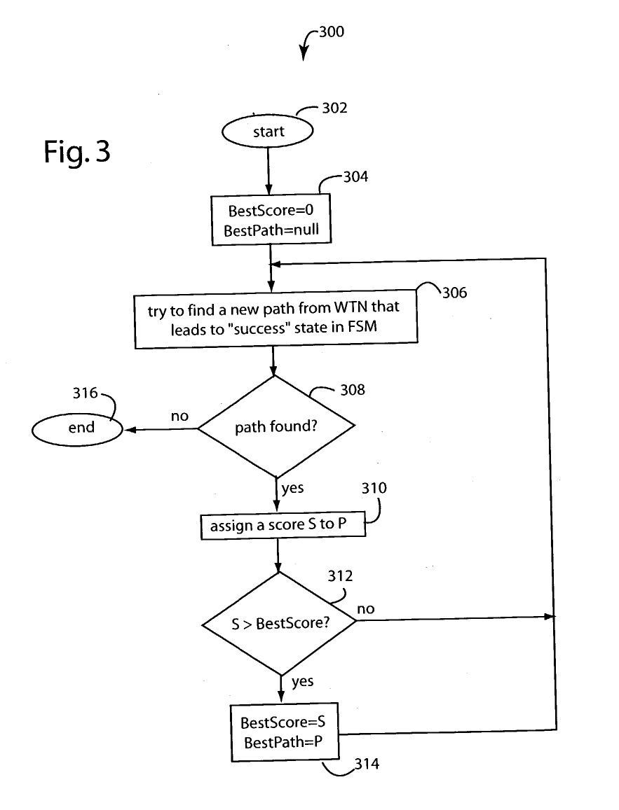

FIG. 3 represents a path search method embodiment of the present invention, and is referred to herein by the general reference numeral 300. The method 300 begins at a starting step 302. A step 304 initializes two variables, BestScore and BestPath to zero and null. A step 306 search for a path from WTN that leads to success, e.g., success state 208 in FIG. 2. A step 306 looks to see if a path has been found. If yes, a step 310 assigns a score S to the path P. A step 312 looks to see if S exceeds the current BestScore. If no, control returns to step 306. If yes, a step 314 updates BestScore to S and BestPath to P. Program control then returns to step 306. If no path was found in step 308, the loop is ended in a step 316.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A method of speech recognition in automated systems, the method comprising:
appointing an automatic speech recognition (ASR) engine to be a primary engine (PE) for processing every speech signal input to a system and for providing a PE-recognition output in every case;
pooling a plurality of ASR engines to be available for appointment as a supplemental engine (SE) that selectively process said speech signal input and for providing an SE-recognition output;
using a work control unit (WCU) to assess and engage any of said supplemental engines for further processing of said speech signal input; and
combining said PE-recognition output and any SE-recognition output into a final speech recognition output signal that performs speech recognition better than simply running only the primary engine, and that costs less than merely running all said supplemental engines in every instance.

2. The method of claim 1, wherein:
the step of appointing is such that said primary engine provides a confidence-of-recognition output that indicates a reliability measure of each particular PE-recognition output; and
the step of using is such that the decision of said WCU to use any of said supplemental engines for further processing of said speech signal input is based on said confidence-of-recognition output.

3. The method of claim 1, further comprising the preliminary step of:
categorizing said ASR engines according to their individual error rates, processing speed, purchasing costs, and/or performance, for the step of appointing, and in that way for judiciously selecting an appropriate supplemental engine in the step of using.

4. An automatic speech recognition system, comprising:
an automatic speech recognition (ASR) engine appointed to be a primary engine (PE) for processing every speech signal input to a system and for providing a PE-recognition output in every case;
a plurality of ASR engines in a pool and each one available for appointment as a supplemental engine (SE) that selectively process said speech signal input and for providing an SE-recognition output;
a work control unit (WCU) for assessing and engaging any of said supplemental engines for further processing of said speech signal input; and
a combiner for uniting said PE-recognition output and any SE-recognition output into a final speech recognition output signal that performs speech recognition better than simply running only the primary engine, and that costs less than merely running all said supplemental engines in every instance.

5. The system of claim 4, wherein:
the ASR engine appointed to be said primary engine includes a confidence-of-recognition output for indicating a reliability measure of each particular PE-recognition output; and
the WCU is such that its decision to use any of said supplemental engines for further processing of said speech signal input is based on a signal received from said confidence-of-recognition output.

6. The system of claim 4, wherein:
the WCU is such that its decision to use any of said supplemental engines for further processing of said speech signal input is adjustably based on a threshold value that is compared to a measurement received from said confidence-of-recognition output.

7. The system of claim 4, wherein:
said ASR engines are categorized according to their individual error rates, processing speed, purchasing costs, and/or performance, for judiciously selecting during operation an appropriate supplemental engine.

8. The system of claim 4, wherein:
the combiner builds a finite state machine (FSM) from a set of grammar rules, and searches the optimal combination result using said FSM;
wherein the allowable grammar is further constrained.
